(19) United States
(12) Patent Application Publication
(10) Pub. No.: US 2026/0177211 A1
(43) Pub. Date: Jun. 25, 2026

(54) DYNAMIC STATIC ELECTRICITY MITIGATION IN FLUID PIPELINES

(71) Applicant: International Business Machines Corporation, Armonk, NY (US)

(72) Inventors: Sarbajit Kumar Rakshit, Kolkata (IN); Sathya Santhar, Ramapuram (IN); Sridevi Kannan, Katupakkam (IN)

(21) Appl. No.: 18/991,820

(22) Filed: Dec. 23, 2024

(51) Int. Cl. F17D 5/08

(52) U.S. Cl. CPC F17D 5/08

(57) ABSTRACT

Systems and methods for mitigating static electricity in a pipeline system are provided. Aspects include receiving a model of the pipeline system and performing a Computational Fluid Dynamics (CFD) simulation. Aspects also include determining anticipated static electricity generation for each pipeline segment based on the simulation and calculating flow parameters to minimize static electricity and dynamically controls flow control devices to achieve these parameters. The model includes a three-dimensional representation of the pipeline's geometry, size, bends, and material properties. Aspects also include monitoring actual flow parameters and static electricity levels using sensors, and dynamically controlling static electricity neutralization devices to dissipate static electricity generated in the pipeline system.

### BACKGROUND

The disclosure relates generally to fluid dynamics and pipeline engineering, and more specifically to the mitigation of static electricity in fluid flow through pipelines using computational fluid dynamics simulations.

Various industries face safety challenges due to static electricity generated during fluid flow through pipelines. The movement of fluids through pipes can lead to triboelectric charging, where friction between the fluid and pipe material results in electron transfer. This process can cause materials to become oppositely charged, leading to the accumulation of static electricity.

Factors such as flow velocity, fluid conductivity, pipe material, surface roughness, temperature, and pressure influence static electricity generation. Higher flow velocities and non-conductive fluids are more prone to static charge accumulation. Traditional methods of mitigating static electricity, such as grounding equipment and using anti-static materials, may not suffice in complex pipeline systems. The need for advanced solutions to manage static electricity buildup is necessary to prevent hazardous situations.

### SUMMARY

According to one aspect of the present invention, a computer-implemented method for dynamically mitigating static electricity in a fluid pipeline is provided. The method includes receiving a model of the pipeline system and performing a Computational Fluid Dynamics (CFD) simulation. The method also includes determining anticipated static electricity generation for each pipeline segment based on the simulation and calculating flow parameters to minimize static electricity and dynamically controls flow control devices to achieve these parameters. The model includes a three-dimensional representation of the pipeline's geometry, size, bends, and material properties. The method further includes monitoring actual flow parameters and static electricity levels using sensors, and dynamically controlling static electricity neutralization devices to dissipate static electricity generated in the pipeline system.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a block diagram of a computing environment, according to one or more embodiments;

FIG. 2 illustrates a block diagram of system for dynamically mitigating static electricity in a fluid pipeline, according to one or more embodiments;

FIG. 3A illustrates a fluid flow through a fluid pipeline, according to one or more embodiments;

FIG. 3B illustrates a cross-sectional view of a fluid pipeline, according to one or more embodiments;

FIG. 4 illustrates a flow chart diagram of a method for dynamically mitigating static electricity in a fluid pipeline according to one or more embodiments; and

FIG. 5 illustrates a flow chart diagram of another method for dynamically mitigating static electricity in a fluid pipeline, according to one or more embodiments.

The detailed description explains embodiments of the disclosure, together with advantages and features, by way of example with reference to the drawings.

### DETAILED DESCRIPTION

Static electricity generation during fluid flow through pipelines presents significant safety challenges across various industries. The movement of fluids through pipes can lead to triboelectric charging, where friction between the fluid and pipe material results in electron transfer. This process can cause materials to become oppositely charged, leading to the accumulation of static electricity. Factors such as flow velocity, fluid conductivity, pipe material, surface roughness, temperature, and pressure influence static electricity generation. Higher flow velocities and non-conductive fluids are more prone to static charge accumulation.

Traditional methods of mitigating static electricity, such as grounding equipment and using anti-static materials, may not suffice in complex pipeline systems. These conventional approaches often fail to address the dynamic nature of fluid flow and the varying conditions within pipelines. The inability to adapt to changes in flow parameters and environmental conditions can result in inadequate neutralization of static electricity, posing risks of sparks, fires, or explosions.

In exemplary embodiments, methods and systems for mitigating static electricity in a pipeline system are provided. The method includes receiving a model of the pipeline system, performing a Computational Fluid Dynamics (CFD) simulation on the pipeline system, and determining an anticipated static electricity generation based on the CFD simulation for each pipeline segment of the pipeline system. The method also includes calculating flow parameters for each pipeline segment of the pipeline system including velocity, pressure, and temperature based on CFD simulations to minimize static electricity generation in the pipeline system and dynamically controlling one or more flow control devices in the pipeline system to achieve the flow parameters for each pipeline segment of the pipeline system.

By receiving a model of the pipeline system, the method allows for a comprehensive understanding of the pipeline's geometry, including the size, location of bends, and material properties. This detailed modeling enables an accurate simulation of the fluid dynamics, which is used to predict static electricity generation. Performing a Computational Fluid Dynamics (CFD) simulation on the pipeline system enables the identification of potential static electricity generation points. The simulation provides insights into fluid flow characteristics, allowing for precise adjustments to flow parameters to minimize static electricity buildup. In exemplary embodiments, determining anticipated static electricity generation for each pipeline segment based on CFD simulations allows for targeted interventions. This approach ensures that static electricity is managed effectively, reducing the risk of hazardous situations such as sparks or explosions. In exemplary embodiments, calculating flow parameters, including velocity, pressure, and temperature, based on CFD simulations, ensures that the pipeline operates under optimal conditions. This proactive adjustment of flow parameters helps in maintaining safety and operational efficiency by minimizing static electricity generation. In exemplary embodiments, dynamically controlling flow control devices in the pipeline system to achieve the calculated flow parameters ensures real-time adaptation to changing conditions. This dynamic control enhances the system's ability to prevent static electricity-related accidents, thereby improving safety and reliability in fluid transportation.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

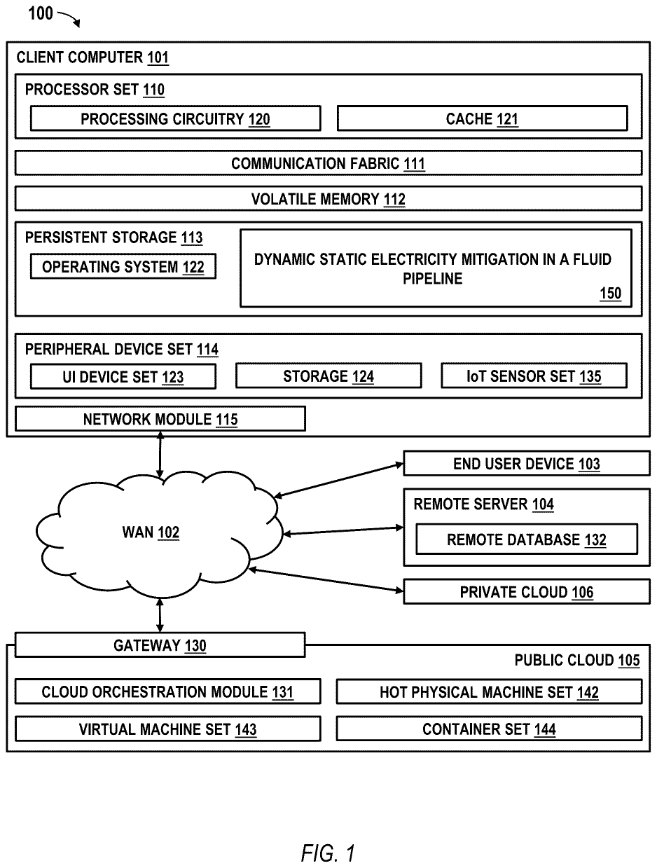

FIG. 1 illustrates a computing environment 100, according to an embodiment. Computing environment 100 contains an example of an environment for the execution of at least some of the computer code involved in performing the inventive methods, such as dynamic static electricity mitigation in a fluid pipeline, as shown at block 150. In addition to a controller for controlling the operations of a metal cutting tool, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in persistent storage 113 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide for remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the owner of the entity is also updated).

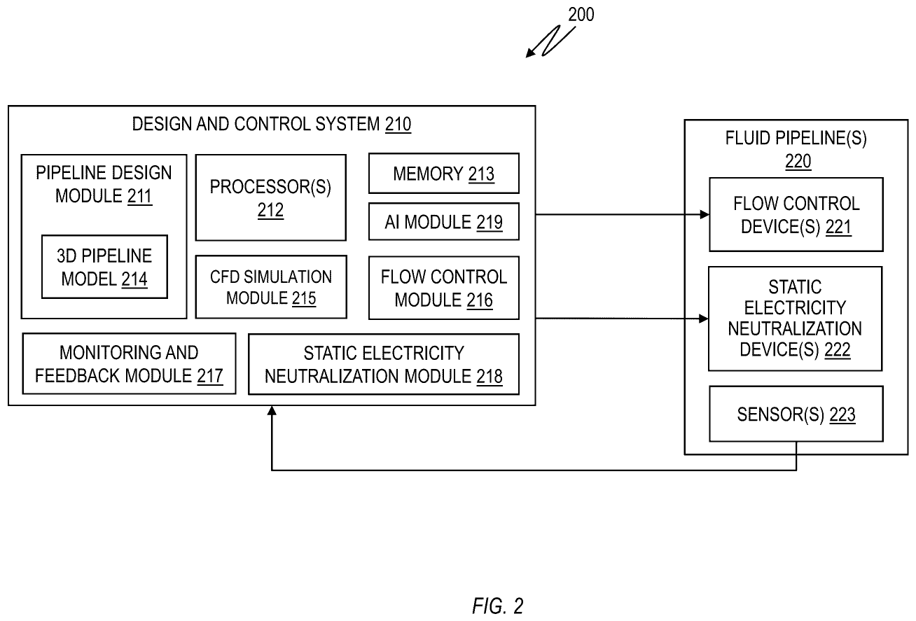

Referring now to FIG. 2, a block diagram of a system 200 for dynamically mitigating static electricity in a fluid pipeline is shown. In exemplary embodiments, the system 200 utilizes a combination of computational fluid dynamics (CFD) simulations and real-time control mechanisms to optimize fluid flow through fluid pipelines 220 to control the generation and dissipation of static electricity. In exemplary embodiments, the fluid pipelines 220 serve as conduits for fluid transport within a pipeline system. These pipelines are modeled in three dimensions, capturing the geometry, including the size, location of bends, and material properties. The design and control system 210 and the pipelines 220 interact with other components to ensure optimal flow conditions and minimize static electricity buildup.

In exemplary embodiments, the design and control system 210 includes a pipeline design module 211 that is configured to create a three-dimensional pipeline model 214 of the fluid pipelines 220 of a pipeline system. The design and control system 210 also includes one or more processors 212, a memory 213, a computational fluid dynamics (CFD) simulation module 215, a flow control module 216, a monitoring and feedback module 217, a static electricity neutralization module 218, and an artificial intelligence (AI) model 218.

In exemplary embodiments, the design and control system 210 is configured to manage the dynamic mitigation of static electricity in fluid pipelines 220. The design and control system 210 integrates various modules and components to ensure optimal fluid flow and static electricity management. The design and control system 210 interacts with the fluid pipelines 220 to monitor and adjust flow parameters, thereby minimizing static electricity buildup. In exemplary embodiment, the pipeline design module 211 within the design and control system 210 is responsible for creating a three-dimensional pipeline model 214. This model captures the geometry of the fluid pipelines 220, including dimensions, bends, and material properties. The pipeline design module 211 provides the necessary data for accurate Computational Fluid Dynamics (CFD) simulations, enabling precise analysis of fluid flow and static electricity generation.

In exemplary embodiment, the processor(s) 212 in the design and control system 210 execute the computational tasks required for CFD simulations and real-time control. The processor(s) 212 handle data processing, simulation execution, and decision-making processes, ensuring that the system responds effectively to changing conditions within the fluid pipelines 220. The memory 213 stores the data and instructions necessary for the operation of the design and control system 210. The memory 213 retains the pipeline model, simulation results, and control algorithms, providing quick access to information required for dynamic adjustments and static electricity mitigation.

In exemplary embodiments, the 3D pipeline model 214 represents the detailed geometry of the fluid pipelines 220. This model serves as the foundation for CFD simulations, allowing for accurate predictions of fluid dynamics and static electricity generation. The 3D pipeline model 214 enables the system to identify potential hotspots, i.e., locations where static electricity may be generated, and optimize flow conditions.

In exemplary embodiments, the CFD simulation module 215 performs the computational fluid dynamics simulations on the pipeline model. The CFD simulation module 215 analyzes fluid flow characteristics, such as velocity, pressure, and temperature, to predict static electricity generation. The results guide the design and control system 210 in making informed decisions about flow control and static electricity neutralization.

In exemplary embodiments, the CFD simulation module 215 is configured to analyze fluid dynamics within the pipeline system. It begins by receiving input data from the 3D pipeline model 214, which includes the geometry of the pipeline, such as dimensions, bends, and material properties, as well as fluid characteristics like density, viscosity, and thermal conductivity. The pipeline geometry is divided into a mesh of small computational cells, allowing the simulation to solve fluid dynamics equations at discrete points and providing a detailed view of fluid behavior throughout the pipeline. In one embodiment, the simulation uses the Navier-Stokes equations to describe the motion of fluid substances, accounting for factors like velocity, pressure, temperature, and turbulence. Boundary conditions are set to define how the fluid interacts with the pipeline walls and any inlets or outlets, including parameters like inlet velocity, pressure, and temperature, which influence the simulation's accuracy. Numerical methods are employed to solve the governing equations, approximating the solutions at each mesh point to predict fluid behavior under various conditions.

In exemplary embodiments, the simulation runs iteratively, adjusting calculations until it reaches convergence, where changes between iterations are minimal, ensuring that the results accurately reflect the fluid dynamics within the pipeline. Once complete, the results are analyzed to identify key fluid flow characteristics, such as velocity profiles, pressure distribution, and temperature variations. These insights help predict static electricity generation and identify potential hotspots. The results from the CFD simulation are integrated with the control system to inform real-time adjustments. The simulation data guides the flow control module 216 and static electricity neutralization module 218 in optimizing flow conditions and mitigating static electricity. The simulation can be rerun as needed to account for changes in pipeline conditions or fluid properties, creating a continuous feedback loop that ensures the system adapts to dynamic conditions, maintaining safety and efficiency. Overall, the CFD simulation module provides a comprehensive analysis of fluid dynamics, enabling precise control and effective static electricity management within the pipeline system.

In exemplary embodiments, the flow control module 216 manages the regulation of fluid flow within the fluid pipelines 220. The flow control module 216 adjusts flow parameters based on data from the CFD simulations and real-time monitoring, ensuring that the system maintains optimal conditions for fluid transport and static electricity mitigation. In exemplary embodiments, the flow control module 216 controls the operation of the flow control device(s) 221 in the fluid pipelines 220.

In exemplary embodiments, the monitoring and feedback module 217 collects real-time data from sensors 223 within the fluid pipelines 220. The monitoring and feedback module 217 provides continuous updates on flow parameters and static electricity levels, enabling the system to make dynamic adjustments and maintain safety and efficiency. The sensor(s) 223 monitor flow parameters and static electricity levels within the fluid pipelines 220. The sensor(s) 223 provide real-time data on fluid velocity, pressure, and other relevant metrics, enabling precise control and adjustment of the system to maintain optimal conditions. In exemplary embodiments, the sensors 223 used in the pipeline system include various types to monitor different parameters. Flow sensors measure the velocity and flow rate of the fluid, providing essential data for maintaining optimal flow conditions. Pressure sensors detect changes in fluid pressure, helping to identify potential issues such as blockages or leaks. Temperature sensors monitor the fluid temperature, ensuring it remains within safe operational limits and aiding in predicting static electricity generation. Static electricity sensors measure the levels of static electricity within the pipeline, allowing for real-time adjustments to neutralization devices. Conductivity sensors assess the fluid's ability to conduct electricity, which can influence static charge accumulation. Additionally, vibration sensors detect vibrations in the pipeline, indicating turbulence or mechanical issues affecting fluid flow. Each of these sensors provides critical data that feeds into the control system, enabling precise monitoring and management of the pipeline's operational conditions.

In exemplary embodiments, the static electricity neutralization module 218 is responsible for dissipating static electricity generated within the fluid pipelines 220. The static electricity neutralization module 218 operates based on data from the monitoring and feedback module 217 and CFD simulations, preventing hazardous situations by neutralizing static charges. In exemplary embodiments, the static electricity neutralization module 218 may control the operation of the flow control device(s) 221 and/or static electricity neutralization devices 222 in the fluid pipelines 220.

The flow control device(s) 221 regulate the flow of fluid through the fluid pipelines 220. The flow control device(s) 221 adjust flow parameters in response to data from the monitoring and feedback module 217, ensuring that the system maintains optimal conditions for fluid transport and static electricity mitigation. The flow control devices 221 in the pipeline system include various types to regulate fluid flow effectively. Valves, such as gate valves, ball valves, and butterfly valves, can be adjusted to control the flow rate and pressure within the pipeline. Diverters are used to redirect fluid flow to different sections of the pipeline, helping manage flow distribution and reduce static electricity buildup. Variable speed pumps can dynamically adjust the flow rate, ensuring optimal fluid velocity and pressure. Actuators automate the operation of valves and other control mechanisms, allowing for precise flow adjustments based on real-time data. While primarily used for measurement, some flow meters can also regulate flow by integrating with control systems to maintain desired flow conditions. These devices work together to ensure the pipeline operates under optimal conditions, minimizing static electricity generation and enhancing safety.

The static electricity neutralization device(s) 222 are installed to dissipate static electricity generated within the fluid pipelines 220. The static electricity neutralization device(s) 222 operate based on real-time data from the monitoring and feedback module 217 and CFD simulations, preventing hazardous situations by neutralizing static charges. Static electricity neutralization devices include various types to effectively dissipate static charges within the pipeline system. In one embodiment, a static electricity neutralization device is an ionizing bar that can be electronically activated and deactivated. This device releases ions into the air to neutralize static charges on surfaces and within the fluid. The ionizing bar can be integrated with a control system that allows for electronic activation and deactivation based on real-time data from sensors monitoring static electricity levels. When static electricity levels exceed a predetermined threshold, the control system activates the ionizing bar to release ions and neutralize the charges. Once the static electricity is reduced to safe levels, the device can be deactivated to conserve energy and prolong its operational life. Another example of a static electricity neutralization device is a corona discharge bar. This device can be electronically activated to generate a corona discharge, which neutralizes static electricity in the surrounding area. Integrated with a control system, the corona discharge bar can be turned on or off based on sensor data monitoring static electricity levels. When the static charge exceeds safe limits, the control system activates the bar to emit a discharge that neutralizes the static electricity. Once the levels are reduced, the device can be deactivated, optimizing energy use and extending the device's lifespan

The AI module 219 enhances the system's ability to predict and respond to static electricity generation. The AI module 219 analyzes historical data and simulation results to identify patterns and optimize control strategies, improving the system's overall effectiveness in managing static electricity. In one embodiment, the AI module 219 collects historical data from past operations, including sensor readings, flow parameters, and static electricity levels. This data provides a comprehensive view of how the system has behaved under various conditions. Using machine learning algorithms, the AI module 219 identifies patterns and correlations within this data. For instance, it may detect that certain flow rates or pipeline configurations consistently lead to higher static electricity levels. By recognizing these patterns, the AI module 219 can predict potential static electricity issues before they occur. The AI module 219 also integrates results from CFD simulations, which provide detailed insights into fluid dynamics and static electricity generation. By combining historical data with simulation results, the AI can refine its predictions and recommendations, ensuring they are based on both past performance and theoretical models. Once patterns are identified, the AI module 219 optimizes control strategies by suggesting adjustments to flow control devices and static electricity neutralization devices. For example, it might recommend altering valve positions or activating ionizing bars at specific times to minimize static electricity buildup. Additionally, the AI module 219 continuously learns and adapts. As new data is collected, it updates its models and strategies, ensuring that the system remains effective even as conditions change. This ongoing optimization enhances the system's overall effectiveness in managing static electricity, improving safety and operational efficiency.

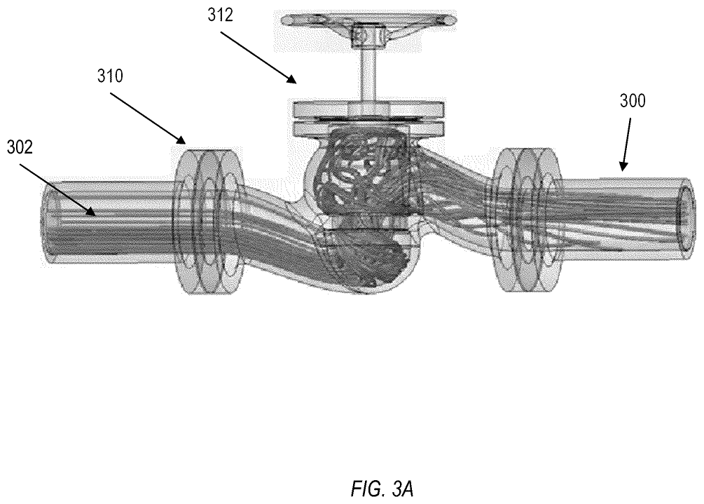

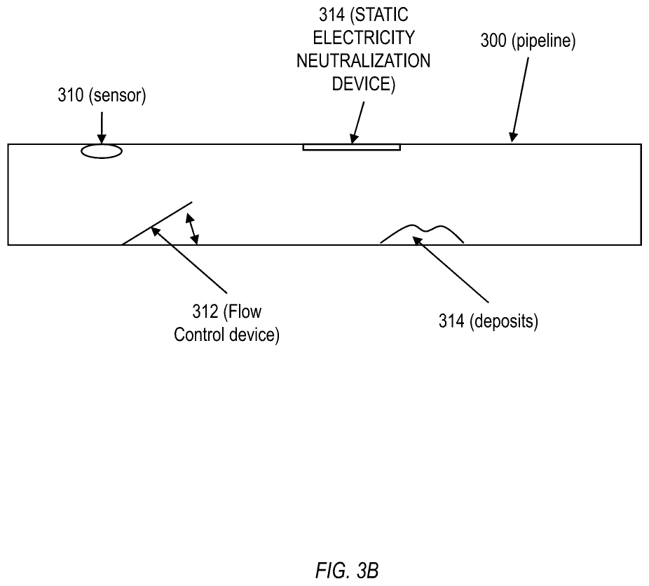

Referring now to FIG. 3A, a fluid flow through a pipeline 300 is shown. As illustrated, a fluid 302 flows through a pipeline 300, which includes a sensor 310 and a flow control device 312. The pipeline 300 is designed to accommodate various flow conditions and is part of the overall fluid transport process. The fluid 302 flows through the pipeline 300, and the characteristics of the fluid 302 such as velocity, temperature, and pressure are measured by the sensors 310. The fluid 302 interacts with the pipeline 300 and the flow control device 312 and may cause creation of static electricity. The sensor 310 monitors the flow parameters of the fluid 302 within the pipeline 300 and may also monitor a level of static electricity in the fluid 302 and/or the pipeline 300. The data provided by the sensor 310 are utilized to control and adjust the flow of fluid 302 through the pipeline 300. The flow control device 312 regulates the flow of the fluid 302 through the pipeline 300. The flow control device 312 adjusts flow parameters in response to data from the sensor 310, ensuring that the system maintains optimal conditions for fluid transport.

FIG. 3B shows a cross-sectional view of a pipeline 300, illustrating the integration of various components for managing static electricity. The pipeline 300 includes a sensor 310, a flow control device 312, a static electricity neutralization device 314, and deposits 314 within the pipeline 300. The pipeline 300 serves as the primary conduit for fluid transport, designed to accommodate various flow conditions. The sensor 310 monitors flow parameters within the pipeline 300, providing real-time data on fluid velocity, pressure, and other relevant metrics. In addition, the sensor 310 may monitor a level of static electricity in the fluid 302 and/or the pipeline 300. The flow control device 312 regulates the flow of fluid through the pipeline 300. The flow control device 312 adjusts flow parameters in response to data from the sensor 310, ensuring that the system maintains optimal conditions for fluid transport and static electricity mitigation. The static electricity neutralization device 314 is installed to dissipate static electricity generated within the pipeline 300. The static electricity neutralization device 314 operates based on real-time data from the sensor 310 and CFD simulations, preventing hazardous situations by neutralizing static charges. The deposits 314 within the pipeline 300 represent areas where material accumulation may occur. These deposits 314 can influence flow dynamics and static electricity generation, necessitating careful monitoring and management.

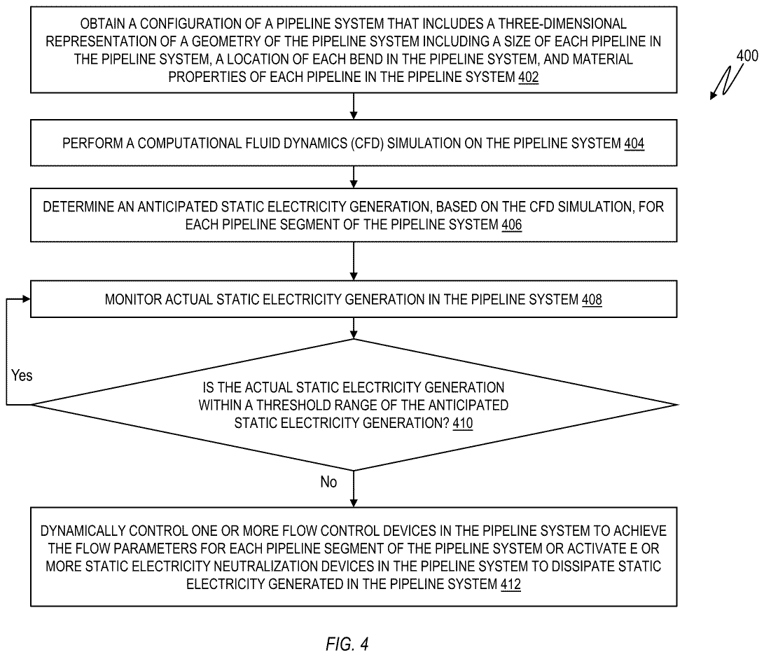

Referring now to FIG. 4, a flowchart illustrating a method 400 for dynamically mitigating static electricity in a fluid pipeline according to one or more embodiments is shown. In exemplary embodiments, the method 400 may be performed via the design and control system 210 shown in FIG. 2. The method 400 beings at block 402 by obtaining a three-dimensional representation of the pipeline's geometry. The three-dimensional representation includes the size of each pipeline, the location of each bend, and the material properties of each pipeline within the system. The configuration serves as the foundational data for subsequent computational fluid dynamics (CFD) simulations. By capturing these details, the system can accurately model the physical characteristics of the pipeline, which are important for predicting fluid dynamics and static electricity generation. The configuration process ensures that all relevant geometric and material factors are considered, providing a comprehensive basis for further analysis.

Next, as shown at block 404, the method 400 includes performing a computational fluid dynamics (CFD) simulation on the pipeline system using the obtained configuration. The CFD simulation analyzes fluid flow characteristics, such as velocity, pressure, and temperature, within the pipeline. By solving fluid dynamics equations at discrete points, the simulation provides a detailed view of fluid behavior throughout the pipeline. The CFD simulation uses the Navier-Stokes equations to describe fluid motion, accounting for factors like turbulence and boundary conditions. This simulation predicts static electricity generation and identifies potential hotspots within the pipeline. The results guide the system in making informed decisions about flow control and static electricity neutralization.

The method 400 also includes making a determination of anticipated static electricity generation is based on the results of the CFD simulation for each pipeline segment, as shown at block 406. In exemplary embodiments, this step involves analyzing the fluid flow characteristics to predict where static electricity may be generated. By identifying potential hotspots, the system can target interventions to manage static electricity effectively. The anticipated static electricity generation data is important for planning the deployment of static electricity neutralization devices and adjusting flow parameters to minimize risks. This proactive approach ensures that static electricity is managed efficiently, reducing the likelihood of hazardous situations.

Next, as shown at block 408, the method 400 includes monitoring of actual static electricity generation 408, which involves collecting real-time data from sensors within the pipeline system. These sensors measure static electricity levels and provide continuous updates on flow parameters. By comparing actual static electricity generation with anticipated levels, the system can assess the effectiveness of current mitigation strategies. This monitoring process enables dynamic adjustments to flow control devices and static electricity neutralization devices, ensuring that the system maintains optimal conditions for fluid transport and safety. The real-time data collected during this step is crucial to the system's ability to adapt to changing conditions and prevent static electricity-related accidents.

At decision block 410, the method 400 includes determining whether the actual static electricity generation is within a threshold range of the anticipated static electricity generation. If the actual levels exceed the threshold, the system initiates corrective actions to address the discrepancy. This decision-making process maintains safety and operational efficiency within the pipeline system. By continuously comparing actual and anticipated static electricity levels, the system can identify deviations and implement necessary adjustments to mitigate risks.

Next, as shown at block 412, the method 400 includes dynamically controlling the flow control devices and/or the activating one or more static electricity neutralization devices. In exemplary embodiments, this step involves adjusting flow parameters and activating neutralization devices based on real-time data and CFD simulation results. The flow control devices regulate fluid flow to achieve the desired parameters, while the neutralization devices dissipate static electricity generated within the pipeline. This dynamic control ensures that the system responds effectively to changing conditions, maintaining safety and reliability in fluid transportation. By integrating real-time monitoring with proactive control measures, the system optimizes fluid flow and minimizes static electricity generation.

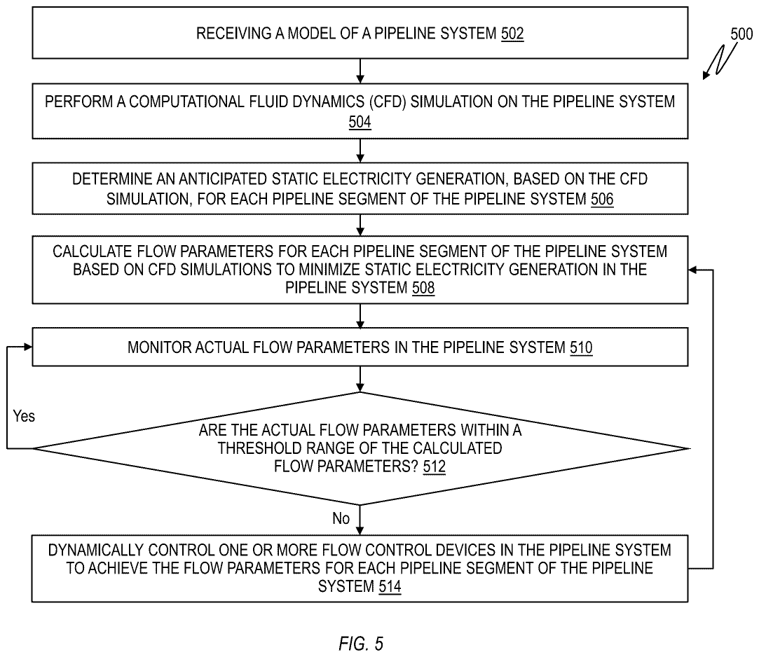

Referring now to FIG. 5, a flowchart illustrating a method 500 for dynamically mitigating static electricity in a fluid pipeline according to one or more embodiments is shown. In exemplary embodiments, the method 500 may be performed via the design and control system 210 shown in FIG. 2. The method 500 beings at block 502 by receiving a model of a pipeline system 502. The model of a pipeline system serves as the foundational input for the computational fluid dynamics (CFD) simulation. This model encompasses a three-dimensional representation of the pipeline's geometry, including the size of each pipeline, the location of each bend, and the material properties. The model provides a comprehensive understanding of the pipeline's physical characteristics, enabling accurate simulation of fluid dynamics and static electricity generation. The model's detailed representation allows for precise analysis and prediction of flow behavior, which is necessary for subsequent steps in the method.

Next, as shown at block 504, the method 500 includes performing a computational fluid dynamics (CFD) simulation of the pipeline system using the model. In exemplary embodiments, the CFD simulation analyzes fluid flow characteristics, such as velocity, pressure, and temperature, within the pipeline. By solving fluid dynamics equations at discrete points, the simulation provides a detailed view of fluid behavior throughout the pipeline. The CFD simulation uses the Navier-Stokes equations to describe fluid motion, accounting for factors like turbulence and boundary conditions. This simulation predicts static electricity generation and identifies potential hotspots within the pipeline, guiding the system in making informed decisions about flow control and static electricity neutralization.

The method 500 also includes determining an anticipated static electricity generation based on the results of the CFD simulation for each pipeline segment, as shown at block 506. In exemplary embodiments, the step involves analyzing the fluid flow characteristics to predict where static electricity may be generated. By identifying potential hotspots, the system can target interventions to manage static electricity effectively. The anticipated static electricity generation data is important for planning the deployment of static electricity neutralization devices and adjusting flow parameters to minimize risks. This proactive approach ensures that static electricity is managed efficiently, reducing the likelihood of hazardous situations.

The calculation of flow parameters 508 for each pipeline segment of the pipeline system is based on CFD simulations to minimize static electricity generation. This step involves determining optimal flow parameters, including velocity, pressure, and temperature, to ensure that the pipeline operates under conditions that reduce static electricity buildup. The calculated flow parameters guide the system in maintaining safety and operational efficiency by minimizing static electricity generation. This proactive adjustment of flow parameters helps in maintaining optimal conditions for fluid transport and static electricity mitigation.

Next, as shown at block 504, the method 500 includes monitoring actual flow parameters 510 in the pipeline system by collecting real-time data from sensors within the pipeline. These sensors measure flow parameters such as velocity, pressure, and temperature, providing continuous updates on the pipeline's operational conditions. By comparing actual flow parameters with the calculated values, the system can assess the effectiveness of current mitigation strategies. This monitoring process enables dynamic adjustments to flow control devices and static electricity neutralization devices, ensuring that the system maintains optimal conditions for fluid transport and safety.

At decision block 512, the method 500 includes determining whether the actual flow parameters are within a threshold range of the calculated flow parameters involves a decision-making process that maintains safety and operational efficiency within the pipeline system. If the actual levels exceed the threshold, the system initiates corrective actions to address the discrepancy. By continuously comparing actual and anticipated flow parameters, the system can identify deviations and implement necessary adjustments to mitigate risks. This decision-making process ensures that the system responds effectively to changing conditions, maintaining safety and reliability in fluid transportation.

Next, as shown at block 504, the method 500 includes dynamically controlling of one or more flow control devices 514 in the pipeline system to achieve the flow parameters for each pipeline segment involves adjusting flow parameters and activating neutralization devices based on real-time data and CFD simulation results. The flow control devices regulate fluid flow to achieve the desired parameters, while the neutralization devices dissipate static electricity generated within the pipeline. This dynamic control ensures that the system responds effectively to changing conditions, maintaining safety and reliability in fluid transportation. By integrating real-time monitoring with proactive control measures, the system optimizes fluid flow and minimizes static electricity generation.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method for mitigating static electricity in a pipeline system, comprising:
receiving a model of the pipeline system;
performing a Computational Fluid Dynamics (CFD) simulation on the pipeline system;
determining an anticipated static electricity generation, based on the CFD simulation, for each pipeline segment of the pipeline system;
calculating flow parameters for each pipeline segment of the pipeline system, based on CFD simulations to minimize static electricity generation in the pipeline system; and
dynamically controlling one or more flow control devices in the pipeline system to achieve the flow parameters for each pipeline segment of the pipeline system.

2. The computer-implemented method of claim 1, wherein the model of the pipeline system includes three-dimensional representation of a geometry of the pipeline system including a size of each pipeline in the pipeline system, a location of each bend in the pipeline system, and material properties of each pipeline in the pipeline system.

3. The computer-implemented method of claim 1, wherein the CFD simulation determines fluid flow characteristic in each pipeline segment of the pipeline system and fluid temperature in each pipeline segment of the pipeline system based on an inlet pressure and outlet pressure of the pipeline system.

4. The computer-implemented method of claim 1, wherein one or more segments of the pipeline system includes a static electricity neutralization device and wherein the method further comprises dynamically controlling the static electricity neutralization device to dissipate static electricity generated in the pipeline system.

5. The computer-implemented method of claim 1, further comprising monitoring, via one or more sensors in the pipeline system, actual flow parameters of fluid through the pipeline system.

6. The computer-implemented method of claim 5, comparing the actual flow parameters of a fluid through the pipeline system with the calculated flow parameters and adjusting the one or more flow control devices in the pipeline system to achieve the flow parameters for each pipeline segment of the pipeline system.

7. The computer-implemented method of claim 1, further comprising monitoring, via one or more sensors in the pipeline system, static electricity levels in the pipeline system.

8. The computer-implemented method of claim 7, further comprising dynamically controlling one or more static electricity neutralization devices in the pipeline system to dissipate static electricity generated in the pipeline system.

9. A system comprising:
a memory comprising computer readable instructions; and
a processing device for executing the computer readable instructions, the computer readable instructions controlling the processing device to perform operations comprising:
receiving a model of a pipeline system;
performing a Computational Fluid Dynamics (CFD) simulation on the pipeline system;
determining an anticipated static electricity generation, based on the CFD simulation, for each pipeline segment of the pipeline system;
calculating flow parameters for each pipeline segment of the pipeline system, based on CFD simulations to minimize static electricity generation in the pipeline system; and
dynamically controlling one or more flow control devices in the pipeline system to achieve the flow parameters for each pipeline segment of the pipeline system.

10. The system of claim 9, wherein the model of the pipeline system includes three-dimensional representation of a geometry of the pipeline system including a size of each pipeline in the pipeline system, a location of each bend in the pipeline system, and material properties of each pipeline in the pipeline system.

11. The system of claim 9, wherein the CFD simulation determines fluid flow characteristic in each pipeline segment of the pipeline system and fluid temperature in each pipeline segment of the pipeline system based on an inlet pressure and outlet pressure of the pipeline system.

12. The system of claim 9, wherein one or more segments of the pipeline system includes a static electricity neutralization device and wherein the operations further comprise dynamically controlling the static electricity neutralization device to dissipate static electricity generated in the pipeline system.

13. The system of claim 9, wherein the operations further comprise monitoring, via one or more sensors in the pipeline system, actual flow parameters of fluid through the pipeline system.

14. The system of claim 13, wherein the operations further comprise comparing the actual flow parameters of a fluid through the pipeline system with the calculated flow parameters and adjusting the one or more flow control devices in the pipeline system to achieve the flow parameters for each pipeline segment of the pipeline system.

15. The system of claim 9, wherein the operations further comprise monitoring, via one or more sensors in the pipeline system, static electricity levels in the pipeline system.

16. The system of claim 15, wherein the operations further comprise dynamically controlling one or more static electricity neutralization devices in the pipeline system to dissipate static electricity generated in the pipeline system.

17. A computer program product for mitigating static electricity in a pipeline system, the computer program product comprising:
a set of one or more computer-readable storage media;
program instructions, collectively stored in the set of one or more storage media, for causing a processor set to perform the following computer operations:
receiving a model of the pipeline system;
performing a Computational Fluid Dynamics (CFD) simulation on the pipeline system;
determining an anticipated static electricity generation, based on the CFD simulation, for each pipeline segment of the pipeline system;
calculating flow parameters for each pipeline segment of the pipeline system, based on CFD simulations to minimize static electricity generation in the pipeline system; and
dynamically controlling one or more flow control devices in the pipeline system to achieve the flow parameters for each pipeline segment of the pipeline system.

18. The computer program product of claim 17, wherein the model of the pipeline system includes three-dimensional representation of a geometry of the pipeline system including a size of each pipeline in the pipeline system, a location of each bend in the pipeline system, and material properties of each pipeline in the pipeline system.

19. The computer program product of claim 17, wherein the CFD simulation determines fluid flow characteristic in each pipeline segment of the pipeline system and fluid temperature in each pipeline segment of the pipeline system based on an inlet pressure and outlet pressure of the pipeline system.

20. The computer program product of claim 17, wherein one or more segments of the pipeline system includes a static electricity neutralization device and wherein the operations further comprise dynamically controlling the static electricity neutralization device to dissipate static electricity generated in the pipeline system.
